(19) United States
(12) Patent Application Publication
(10) Pub. No.: US 2008/0096168 A1
(43) Pub. Date: Apr. 24, 2008

(54) Tooth Implant

(75) Inventor: Alwin Schonenberger, Berg (CH)

Correspondence Address: RISSMAN JOBSE HENDRICKS & OLIVERIO, LLP, 100 Cambridge Street, Suite 2101, BOSTON, MA, 02114, US

(73) Assignee: Straumann Holding AG, Basel (CH)

(21) Appl. No.: 11/718,733

(22) PCT Filed: Nov. 2, 2005
(86) PCT No.: PCT/CH05/00639

§ 371 Date: Jun. 11, 2007

(30) Foreign Application Priority Data
Nov. 8, 2004 (CH) 1 832/04

(51) Int. Cl. A61C 8/00; B25B 23/08

(52) U.S. Cl. 433/174; 81/459

(57) ABSTRACT

A dental implant system, comprising an implant and a secondary piece, which is fixed to the implant such as not to rotate and on which a superior construction may be installed. A positioning tool is also provided, to transfer the position of the implant in the mouth of the patient onto a model. The implant comprises a recess extending inwards from a coronal front side, into which an apical end of the positioning tool may be introduced. Grooves or ribs are embodied in the recess, which together with corresponding ribs or grooves of the apical end of the positioning tool introduced into the recess, form a stable locking relative to a rotation of the positioning tool about an implant axis.

The invention is in the field of medical engineering and relates to a dental implant system. The dental implant system comprises an implant and a secondary piece (also called an abutment), onto which secondary piece it is possible to mount an add-on element (supraconstruction) which, for example, can form an artificial crown. The implant system also includes optional system-specific auxiliaries for creating a model for the dental technician. The invention also relates to an implant, a secondary piece, a laboratory analog of an implant, and a positioning tool.

Various implant systems are available on the dental market. They are based on a screw body on which an artificial crown or another supraconstruction is mounted via a secondary piece. This procedure makes it possible to compensate for possible incorrect positioning and axial divergence of adjacent implants. Moreover, moving the selection of the secondary piece to a time after the definitive impression has been taken makes it easier to rectify the situation.

Among the systems available on the market, there are products that have an inner polygon (for example a hexagon or an octagon) present in the inside of the implant, and the secondary piece has a corresponding outer polygon which engages as guide surface into the inner polygon, as a result of which the angle position (i.e. the position in the azimuthal direction) of the secondary piece is fixed.

In clinical application, however, there are certain problems with such systems. The positioning of the secondary pieces proves difficult, especially when the implant shoulder lies in a submucosal position, and there are inadequacies regarding the precision fit of the prosthetic supraconstruction, despite the use of prefabricated components. In the laboratory, a lot of time is spent in screwing the secondary pieces in and unscrewing them. However, these work steps cannot be omitted, as they are a precondition for good margin fit.

Initial problems arise in transferring the oral situation to a master model for the dental technician. To do so, a so-called impression tray with impression compound is used that is fitted into the patient's mouth. In certain implant systems, this impression-taking process requires a positioning tool (for example a positioning cylinder) which transfers the correct angle position of the implant from the oral situation to the model situation and has to engage relatively deep in the inner polygon of the implant. Therefore, the removal of the impression may prove difficult depending on the (oblique) position of the implant, and complete resetting of the impression material is not always guaranteed, on account of the considerable delay. Retentive locations in adjacent diverging implants can be almost impossible to overcome in cases of rigid blocking. Moreover, the resetting of the impression material would also be less complete because of the greater delay.

A second set of problems concerns the angle position of the laboratory analog in the model. Because of the necessary tolerances between the polygon configuration of the implant and the positioning tool, on the one hand, and of the positioning tool and laboratory analog, on the other hand, there is a risk of undesired angle deviations. This is all the more so as the deviations can be generally expected in the direction of rotation of the screws and thus accumulate systematically. The rotation movement of the secondary piece can be considerable, especially in the laboratory analog, as a consequence of repeated screwing in and out of the secondary piece.

Although the fastening of the secondary pieces in the inner cone of the implant leads to a very good mechanical blocking between secondary piece and implant (screw-cone connection), there are at the same time, however, other problems that result in inadequate precision. The position of the secondary piece in the laboratory analog and in the implant varies as a function of the tightening moment. Because of the stated tolerances, the inner configurations of the laboratory analog and of the implant are not very suitable for protecting against possible rotation movements of the secondary piece. They are also difficult to handle as positioning aid, particularly if the occlusal screw required for fixing in the implant or laboratory analog is integrated in the secondary piece.

Finally, the secondary pieces vary in terms of their vertical alignment and angle position, i.e. they come to lie in different positions in the laboratory analog and in the implant. In this context, divergences in the angle position are especially disadvantageous, in particular if non-rotationally symmetrical secondary pieces are used. Crown-bridge units on angled secondary pieces will achieve an optimal precision fit (passive fit with good margin closure) only for a defined position of the secondary pieces. When these secondary pieces are transferred from the model to the mouth, they in some cases come to lie in a slightly altered position (depending on the tightening torque), which leads to inadequate fit. Supraconstructions previously running smoothly on the model come to jam on the secondary pieces in the mouth; the margin closure can be achieved only, if at all, by means of a press-fit. Accordingly, the precision appears to be impossible to predict. The alleged advantage of delaying the selection of the secondary piece until the time after the definitive impression has been taken turns out to be a disadvantage of the system, because of the transfer problems.

The object of the invention is to make available an implant system and the corresponding individual parts that overcome the disadvantages of the prior art and in particular permit precise transfer of the implant position from the oral situation to the model.

This object is achieved by the invention as defined in the patent claims.

The dental implant system comprises an implant, and a secondary piece which can be secured on the implant in a rotationally fixed manner and onto which a supraconstruction can be mounted. A positioning tool is additionally provided for transferring the position of the implant in the patient's mouth to a model. The implant has a recess which extends inward from a coronal end face and into which an apical end of the positioning tool can be inserted. It is characterized in that grooves or ribs are formed in the recess and, together with corresponding ribs or grooves at the apical end of the positioning tool inserted into the recess, form a stable locking relative to rotations of the positioning tool about an implant axis.

According to the invention, the implant recess (i.e. the inner funnel) has grooves (they can be designed as guide channels of any desired shape) or ribs that interact with corresponding ribs or grooves of the secondary piece and form a positioning aid and a protection against twisting. These grooves or ribs are preferably immediately adjacent to the coronal end face of the implant, i.e. they are located in the area of the transition between the inner funnel and an optionally present implant shoulder.

“In the area of the transition” means, for the grooves, that they directly adjoin the transition to the implant shoulder, while, in the case of ribs, it means they are at most ca. 2 mm, preferably at most 1 mm, away from the transition.

The “ribs” can have any desired shape as long as they can be inserted into the grooves and have the same width as the latter, except for tolerances. An elongate rectangular shape is preferred, such that the groove/rib connection is as it were a groove/spring connection.

By virtue of the construction according to the invention, it is not necessary for a positioning tool to engage deep into the implant when an impression is being taken. Instead, it only needs to extend into the inner funnel by a short distance, preferably by only 1.5 mm, for example by at most 1 mm. This considerably simplifies the impression-taking process and increases the reliability of the latter, particularly in the case of several implants in non-parallel positions. Moreover, more precise protection against twisting is possible than is the case when an outer polygon engages in an inner polygon. The separation of the positioning means from the fixing means also affords additional possibilities in terms of the design of the implant system. Another important advantage is that the positioning aids can be seen from the outside. The separation of rib and grove system and the inner polygon therefore permits visual monitoring of the insertion of the positioning tool and of the secondary pieces.

According to a preferred embodiment, the number of channels in the implant or secondary piece corresponds to the number of surfaces of the polygon (for example 8 for an octagon) or is an integral multiple or a fraction of the number of surfaces. The number of ribs preferably corresponds to the number of channels or is a fraction of this number (for example 2 or 4 for 8 channels).

According to another preferred embodiment of the invention, a positioning tool for transfer to the model (this instrument of course also has ribs or grooves) is preferably made of metal, thereby increasing the precision.

Products according to the prior art, and embodiments of the invention, are described in more detail below with reference to the drawings, in which:

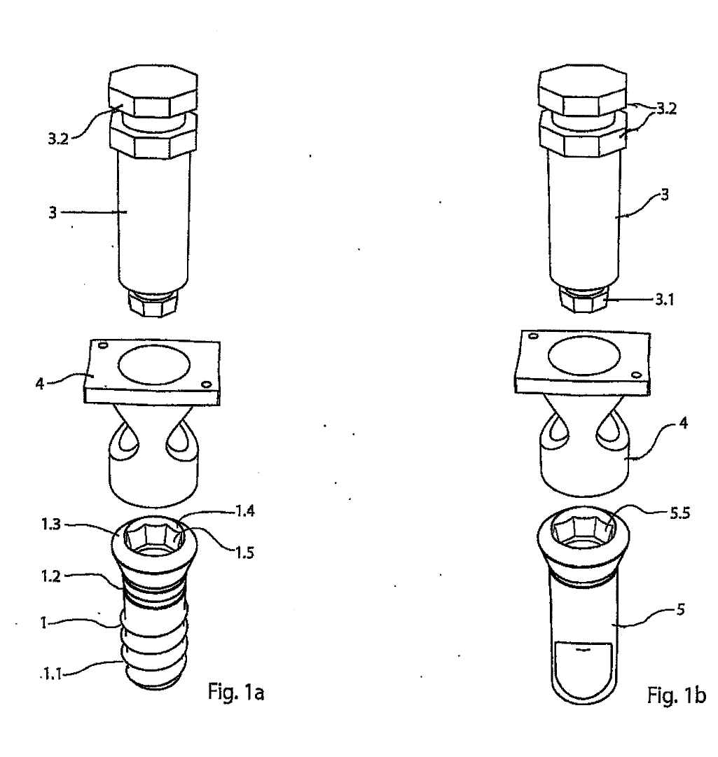

FIG. 1a shows an implant, and FIG. 1b shows the laboratory analog of the implant, according to the prior art, together with an associated positioning tool and an impression cap with snap-fit mechanism.

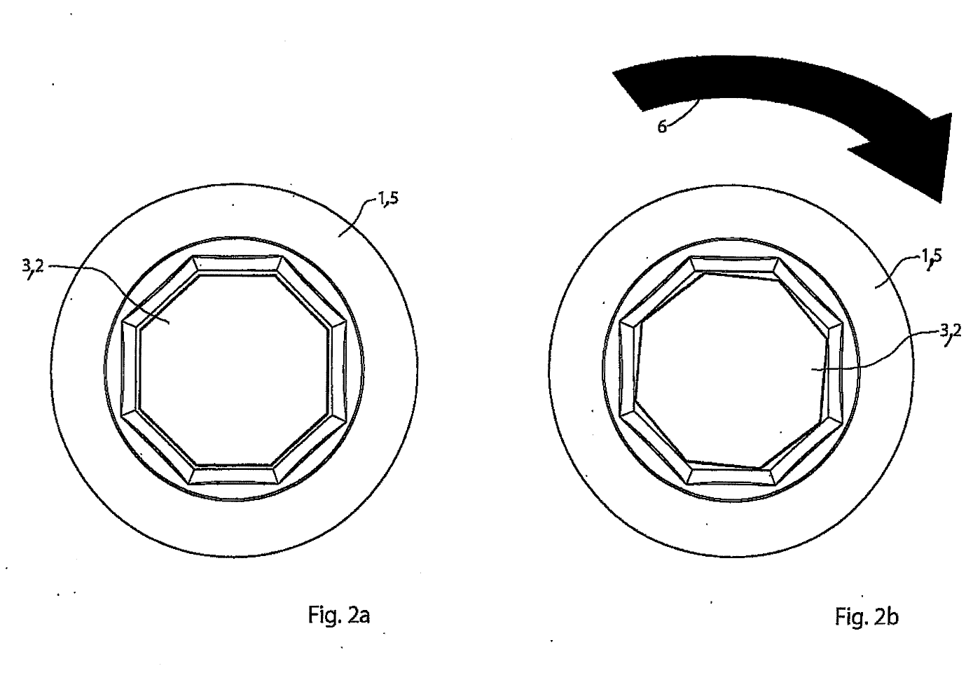

FIG. 2a and FIG. 2b illustrate the problem of the poorly defined angle position obtained between the implant or laboratory analog and the secondary piece or positioning tool.

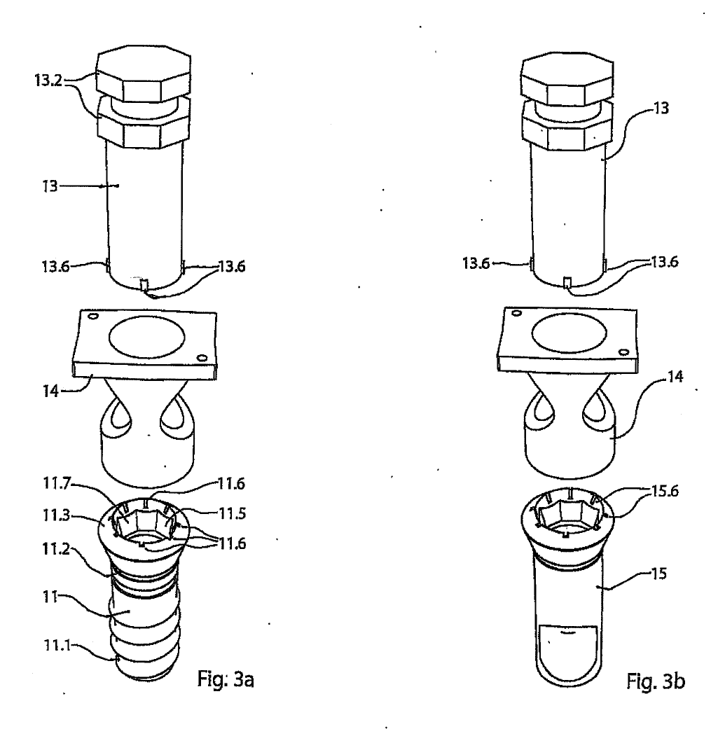

FIG. 3a shows an implant, and FIG. 3b shows a laboratory analog of the implant, according to the invention, together with an associated positioning tool and an impression cap with snap-fit mechanism.

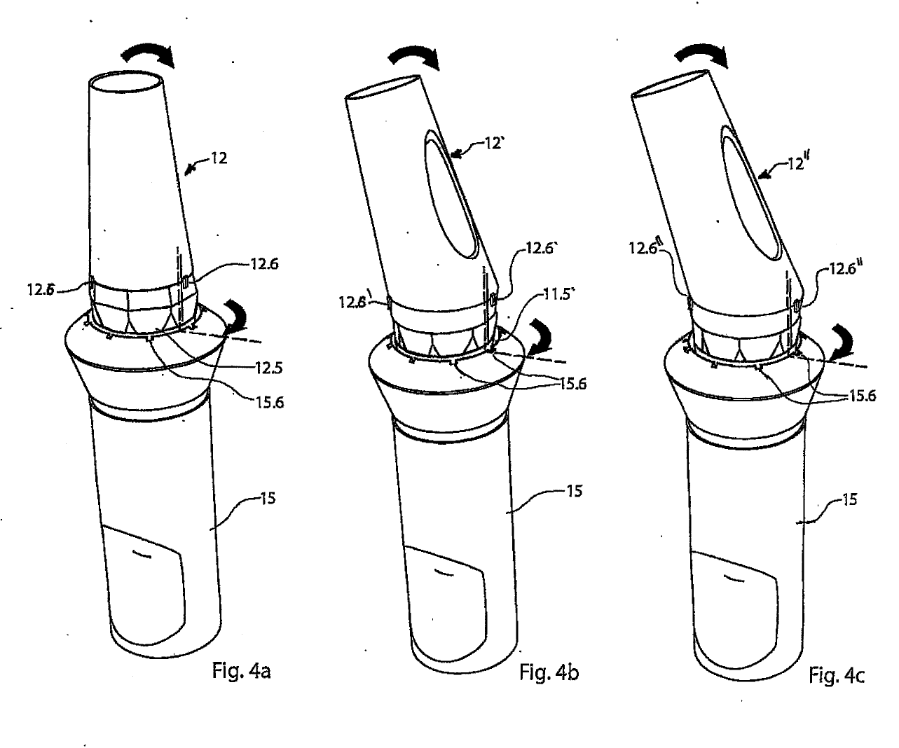

FIGS. 4a to 4c each show an implant laboratory analog according to the invention, together with the three versions of a secondary piece according to the invention.

The implant 1 according to FIG. 1 corresponds to a product available on the market. It comprises an apical area 1.1, designed as a screw, and a coronal area 1.2, and its circumferential surface is designed for osseointegration. At its coronal end face, the implant has a shoulder surface 1.3. An inner funnel is formed which extends inward from the coronal end face and, adjoining a cylindrical or conical portion 1.4, forms an inner polygon 1.5, namely an inner octagon. In the apical direction from the inner polygon 1.5, the implant has an inner thread, which is not visible in the drawing and into which an occlusal screw can be inserted for securing a secondary piece. The implant is made of titanium, for example, or of a titanium alloy.

A positioning tool 3 is made of plastic and has a cylindrical shape. It has an apical outer polygon 3.1 that fits into the inner polygon 1.5 of the implant, and a further outer polygon 3.2 for rotationally fixed anchoring of the positioning tool in the impression upon transfer of the implant angle position to a model. On the basis of the model, a dental technician, if appropriate together with the dentist, can choose the appropriate secondary piece from a selection of secondary pieces and prepare a supraconstruction. To produce the model, an impression of the oral situation is first taken. For this purpose, the positioning tool 3 is inserted into the inner funnel of the implant until the apical outer polygon engages in the inner polygon of the implant. It is guided in this process by an impression cap 4, which can be secured on the implant shoulder by a snap-fit mechanism. The impression cap and the positioning tool are positioning instruments. Upon production of the model from the impression by renewed replication, the positioning tool 3 defines the rotation angle position of the implant laboratory analog 5, which has an inner funnel with inner polygon 5.5 corresponding to the implant structure. The impression cap is used to define the vertical position in the impression-taking process and is required for the correct transfer thereof from the oral situation to the model and for reproduction of the implant shoulder position.

The aforementioned problem of the inadequate definition of the angle position and of the jamming effect is illustrated in FIGS. 2a and 2b. The rotation position of the positioning tool 3 relative to the implant 1 and to the laboratory analog 5 (in the view in the figure, the element 1,5 designates both the implant and the laboratory analog) can vary by a considerable amount, as is shown by the difference between the desired position in FIG. 2a and the jammed position in FIG. 2b. The same imprecision also arises between laboratory analog 5/implant 1 and secondary piece 2 during the work in the laboratory or clinic when securing the secondary piece to the implant for the patient (i.e. the element 3,2 in the figure represents, in addition to the positioning tool, also the secondary piece in cross section). Overall, the imprecision depicted can thus quadruple; all the more so as a deviation from the desired position will generally be observed in the direction of rotation 6 of the screw.

FIG. 3a shown an implant 11 according to the invention, the reference numbers 11.1, 11.2, 11.3 and 11.5 designating, in the same way as for the implant according to FIG. 1a, the apical area, the coronal area, the shoulder surface and an inner polygon. The material of the implant and the osseointegration surface can be chosen the same as in the known implant. In contrast to the prior art, the implant comprises, at the coronal end of the inner funnel, that is to say in the area of the transition between the shoulder surface 11.3 and the inner funnel and adjoining the shoulder surface 11.3, several grooves 11.6 or channels extending in the axial direction. In the embodiment shown, the surface delimiting the inner funnel extends slightly conically in the area of the grooves 11.6, but it could equally well extend cylindrically, or cylindrically and conically. In contrast to the positioning tool for implant systems according to the prior art, the positioning tool 13 does not have a part to be inserted into the interior of the inner funnel, and instead its circumferential surface at the apical end is provided with ribs 13.6 that can be inserted into the grooves of the implant. In this case, it is not essential for each groove to have a corresponding rib on the positioning tool. In the embodiment shown, the instrument has only four ribs, whereas there are eight grooves in the implant.

The ribs and grooves have the function of fixing the angle position (i.e. the azimuthal position) of the positioning tool relative to the inner polygon of the implant or the inner polygon of the laboratory analog. They also mean that, during the impression-taking process, the positioning tool only has to extend (i.e. be inserted) a short distance, for example not more than one millimetre, into the implant until it comes up against an abutment surface of the impression cap. The depth of the grooves should be set such that the engagement of the secondary piece into the implant is not limited by the groove depth.

As has already been mentioned, the fact that the positioning tool extends only a short distance into the implant means that serious disadvantages of the prior art are eliminated.

To optimize the precision, the positioning tool, or at least its apical end, can be made of metal instead of plastic, for example of aluminum or an aluminum alloy. Instead of an impression cap 14 with snap-fit mechanism, screwed versions are also possible. These are, for example, metallic, with an integrated positioning screw, which is screwed into the inner thread of the implant 11.

In FIG. 3b, corresponding to FIG. 1b, the positioning tool 13 and the impression cap 14 are shown together with the laboratory analog 15 with inner polygon 15.5. Like the implant, the laboratory analog 15 also comprises grooves 15.6 for guiding the ribs 13.6 of the positioning tool.

FIGS. 4a, 4b and 4c show three versions of secondary pieces 12, 12′, 12″ that are each positioned in laboratory analogs 15 of the implant according to the invention. According to a preferred embodiment of the invention, the secondary pieces comprise ribs 12.6, 12.6′, 12.6″ that engage in grooves 15.6 (or 11.6) of the laboratory analog 15 (or of the implant) when the secondary piece is in its end position, in which guide surfaces 12.5, 12.5′, 12.5″ extend into the inner funnel of the implant. By virtue of the ribs and grooves, the azimuthal position is much better defined than in the prior art (the choice of a much smaller clearance is possible), and the protection against twisting is more effective.

In addition to the advantage of precise impression-taking and position definition, the described system of ribs and grooves also permits simplified handling in the positioning of the secondary pieces. The direction of insertion and position can be seen with the eye.

The azimuthal positioning is of course particularly critical and important in the embodiments with a secondary piece angled in relation to the implant axis as in FIG. 4b and FIG. 4c, in which the unit made up of implant and secondary piece is not rotationally symmetrical in its outer shape.

The illustration in the drawings is just one of many solutions according to the concept of the invention. The following modifications are possible, for example:
The grooves and ribs can be provided the other way round, i.e. the implant and the laboratory analog can have ribs, while the positioning tool and the secondary piece then have corresponding grooves.
In embodiments in which the implant and the laboratory analog have grooves, the secondary piece does not necessarily need to have corresponding ribs, although this is clearly preferred, and instead, in contrast to the positioning tool, it can also be positioned only via the polygon surfaces.
In the embodiments in which the secondary piece also has ribs, the polygon surfaces in the inner funnel of implant and laboratory analog and on outer surfaces of the secondary piece can also be completely dispensed with, and can be replaced, for example, by a conical or cylindrical part.
The described materials can be replaced. Instead of being made of metal, the positioning tool can also be made from a high-quality plastic.

1. A dental implant system comprising an implant, a secondary piece which can be secured on the implant in a rotationally fixed manner and onto which a supraconstruction can be mounted, and a positioning tool, said implant having a recess which extends inward from a coronal end face and into which an apical end of the positioning tool can be inserted, the recess having grooves or ribs in the recess which, together with corresponding ribs or grooves at the apical end of the positioning tool that is inserted into the recess, form a stable locking relative to rotations of the positioning tool about an implant axis.

2. The implant system of claim 1, further comprising an impression cap which guides the positioning tool and can be secured on the implant during the impression-taking and which, when the apical end of the positioning tool is inserted into the recess, forms a limit stop, such that the apical end of the positioning tool can only be inserted to such an extent that it protrudes by a maximum of 2 mm into the recess.

3. The implant system of claim 1, wherein the recess of the implant in some areas forms an inner polygon surface on which a guide surface of the secondary piece bears when the latter is secured on the implant.

4. The implant system of claim 1 wherein the secondary piece has ribs or grooves which, together with the grooves or ribs of the implant, form a stable locking relative to rotations of the secondary piece about an implant axis when said secondary piece is secured on the implant.

5. An implant having a recess that extends inward from a coronal end face, and grooves or ribs in the recess for rotationally fixed locking of a positioning tool or secondary piece having ribs or grooves corresponding to said grooves or ribs of the implant.

6. The implant of claim 5, wherein the grooves, limited on one side by a coronal end face of the implant, extend in the axial direction.

7. The implant system of claim 4, wherein the secondary piece has ribs or grooves which, together with the grooves or ribs of the implant, form a stable locking relative to rotations of the secondary piece about an implant axis when said secondary piece is secured on the implant.

8. A positioning tool for an implant having an apical end that can be inserted into a recess of the implant, the tool having an apical end with ribs or grooves which form a stable locking relative to rotations of the positioning tool about an implant axis when the apical end is inserted into the recess.

9. The positioning tool of claim 8, wherein the tool is metal.

10. An implant laboratory analog having a recess extending inward from a coronal end face, and grooves or ribs in the recess for rotationally fixed locking of a positioning tool or secondary piece having ribs or grooves corresponding to said grooves or ribs of the analog.

11. The implant system of claim 2, wherein the maximum is 1.5 mm.
